(19) United States
(12) Patent Application Publication
(10) Pub. No.: US 2005/0188636 A1
(43) Pub. Date: Sep. 1, 2005

(54) Coupling nut for high wind applications

(76) Inventor: Robert L. Burns, Knotts Island, NC (US)

Correspondence Address: WILLIAMS MULLEN, FOUNTAIN PLAZA THREE, SUITE 200, 721 LAKEFRONT COMMONS, NEWPORT NEWS, VA, 23606, US

(21) Appl. No.: 11/068,177

(22) Filed: Feb. 28, 2005

Related U.S. Application Data
(60) Provisional application No. 60/548,063, filed on Feb. 26, 2004.

(51) Int. Cl. E02D 27/00; E02D 27/32; F16L 17/00; F16L 19/06; F16L 19/08; F16L 21/02

(52) U.S. Cl. 52/295

(57) ABSTRACT

A coupling nut for anchoring buildings to the ground, particularly in geographic regions subject to high wind conditions. The coupling nut is designed for use with threaded anchoring rods currently used in the construction industry. The coupling nut includes a head and body with at least the body portion being hollow. The internal surface of the body portion is threaded so as to mate with the threaded anchoring rod. The threaded anchoring rod extends into a hole in the foundation of the building. The coupling nut attaches to the rod from the opposite side of the foundation and, when used with an appropriate washer, securely anchors the foundation to the ground.

### CROSS REFERENCE TO RELATED APPLICATIONS

The present application claims priority from U.S. Provisional Application Ser. No. 60/548,063, filed Feb. 26, 2004.

### FIELD OF THE INVENTION

The invention is generally related to coupling nuts for construction use. More particularly, the invention is directed to a coupling nut for use in high wind applications.

### DESCRIPTION OF RELATED ART

In areas subjected to high winds, such as the Mid-Atlantic coastline during hurricane season, building codes generally require that new construction be securely anchored to the ground to resist wind damage. This is normally done with a plurality of “all threads” which are used about the bottom floor of the construction. The all threads are secured into the ground by several means. They can be set in concrete, bent and buried underground or any other appropriate means. A typical all thread is shown in FIG. 1. Previous methods of securing the construction to the all threads have been cumbersome and time consuming. Additionally, previous methods hinder proper inspection of the connection system, making it difficult to ensure that buildings are properly anchored to the ground, particularly in geographic locations which experience high wind conditions.

Accordingly, it is an object of the present invention to provide a coupling nut for use in construction.

It is another object of the present invention to provide a coupling nut for use with threaded anchoring rods known as “all threads.”

It is another object of the present invention to provide a coupling nut which provides particular protection for construction in geographic regions which experience high wind conditions.

It is another object of the present invention to provide a coupling nuts which is adaptable to current construction methods.

It is a further object of the present invention to provide a coupling nut which facilitates inspection of the connection between the coupling nut and threaded anchor rod.

It is yet a further object of the present invention to provide a coupling nut which is simple to use.

Finally, it is an object of the present invention to accomplish the foregoing objectives in a safe and cost effective manner.

### SUMMARY OF THE INVENTION

A coupling nut for anchoring a building to the ground by means of a threaded rod is provided. The coupling nut has a head portion and a body portion. The outer diameter of the head portion is larger than the outer diameter of the body portion. The body portion is hollow and the inner surface of the body portion is threaded to mate to the threaded rod and provide an anchor point between the building and the ground. The head portion is also preferably hollow with a threaded inner surface. The coupling nut is made from a durable, weather resistant material such as cold steel, galvanized steel, zinc plate coated steel or a composite material. The coupling nut may be formed in a single step through a molding process or the head and body portions may be welded. Preferably, the head portion of the coupling nut is hexagonal in cross section and the body portion is circular in cross section. If desired, the coupling nut may include an integral washer element. Alternatively, a separate square or round washer is used with the coupling nut. To allow for imperfections in the threaded rod, the inner surface of the body portion of the coupling nut may be tapered such that the diameter of the exit opening is larger than the diameter at the center of the body portion. If a hollow head portion is employed, the exit opening may also be larger.

### BRIEF DESCRIPTION OF THE DRAWINGS

FIG. 1 is a perspective view of an all thread as used in the prior art methods;

FIG. 2 is a side view of the preferred embodiment of the present invention with the inner surface shown;

FIG. 3 is a top view of the preferred embodiment of the present invention along III-III in FIG. 2 with the inner surface shown;

FIG. 4 is bottom view of the preferred embodiment of the present invention along IV-IV in FIG. 2 with the inner surface shown;

FIG. 5 is an end view of the preferred embodiment of the present invention showing all surfaces;

FIG. 6 is side cross-sectional view of the preferred embodiment of the present invention;

FIG. 7a is an end view of the preferred embodiment of the present invention;

FIG. 7b shows a side view of the preferred embodiment of the present invention;

FIG. 8 is a side view of an alternate embodiment of the present invention with the inner surface shown; and

FIG. 9 shows a side view of the preferred embodiment of the present invention in use.

### ELEMENT LIST

10 Coupling nut
12 Body of coupling nut
14 Head of coupling nut
16 Inner surface of coupling nut
18 Washer
20 Threaded rod
22 All thread
23 Opening
24 Construction material

### DETAILED DESCRIPTION OF THE PREFERRED EMBODIMENT

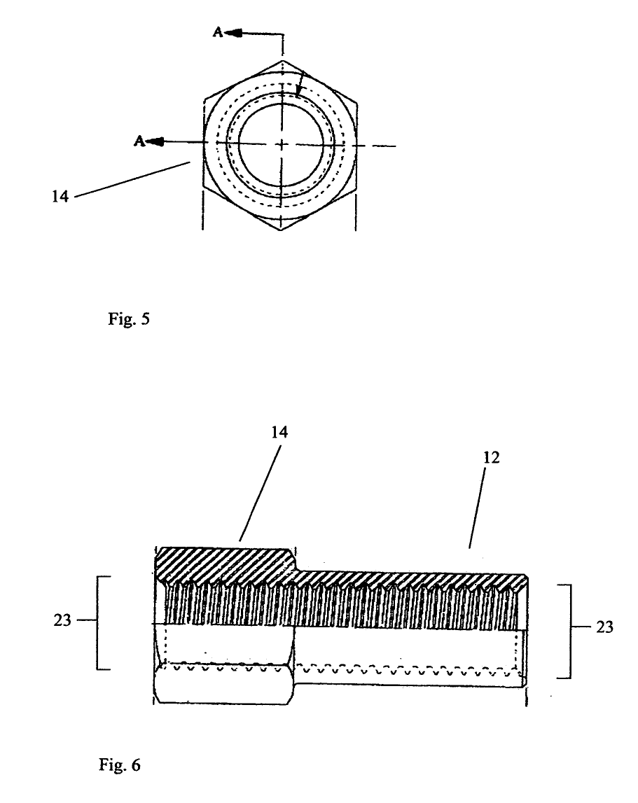

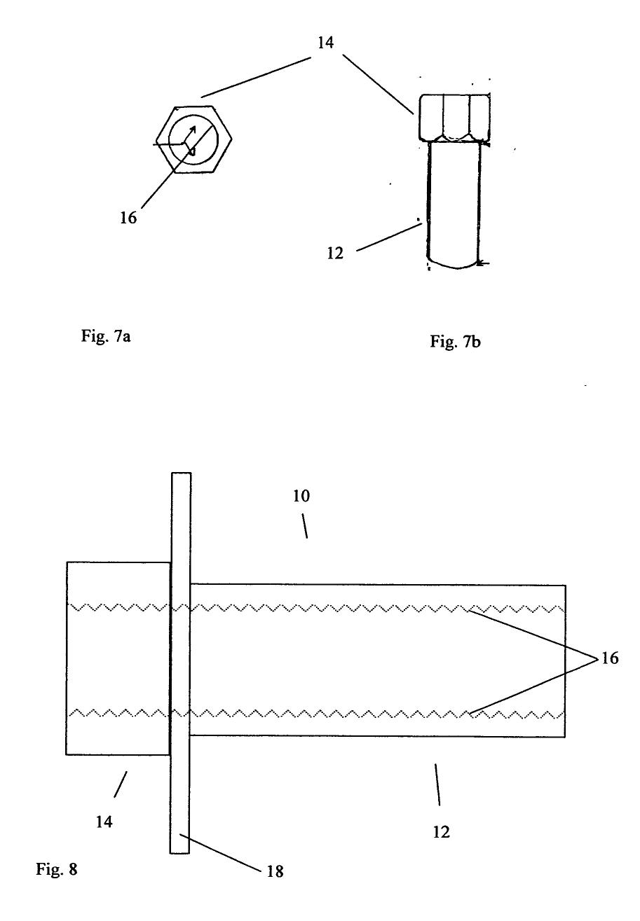

Referring now to the drawings, FIGS. 2-9 show several views of the preferred embodiment of the present invention. While the preferred embodiment is specifically described for use with an “all thread” anchoring apparatus, the coupling nut can be used with any threaded anchoring apparatus. Further, while the invention is most appropriately used for construction in areas subject to significant wind conditions such as hurricanes, the invention can be used in any construction where additional anchoring strength is needed or may be used to facilitate construction in any environment.

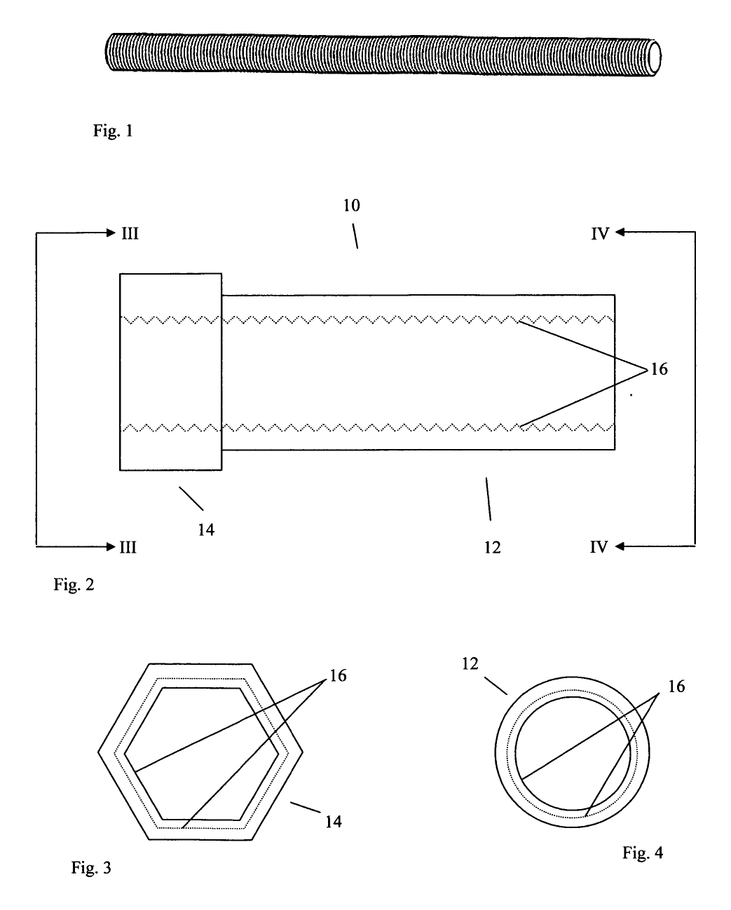

FIG. 1 shows a standard all thread 22 as is commonly used in construction. FIGS. 2-9 show the present invention, an improved coupling nut 10. The coupling nut 10 is made from a durable, heavy duty material such as cold or galvanized steel or zinc plate coated steel. Other materials, such as composites are also appropriate. The coupling nut 10 is preferably formed as a single piece, normally through a molding process, but can also be welded.

The coupling nut 10 preferably has a cylindrical body 12 and a hexagonal head 14. While other shapes will provide the same function, these shapes are preferred for ease of use at construction sites with currently available tools. The inner surface 16 of the coupling nut 10 is threaded to mate with the all thread 22 being used. FIG. 3 shows a top view of the coupling nut 10, showing the hexagonally shaped head 14 and the inner surface 16 of the coupling nut 10. FIG. 4 is a bottom view of the coupling nut 10, showing the generally cylindrical shape of the body 12 and, again, the inner surface 16 of the coupling nut 10. The coupling nut 10 is long enough to insure that the coupling nut 10 is securely mated to the all thread 22; a length of at least five threads is generally considered to be necessary to provide the needed holding strength. The coupling nut 10 can be as long as the construction environment allows.

While the figures show a coupling nut 10 which is hollow along its entire length, a coupling nut 10 with a solid, non-hollow head 14 also accomplishes the anchoring function of the coupling nut 10. A hollow head 14 is preferred to allow easy inspection and to allow the mating of another threaded rod 20 from above as is often desired. Such inspection is not facilitated by previously known methods for coupling to an all thread 22.

If desired, as shown in FIG. 6, the inner surface 16 of the coupling nut 10 may be slightly larger at either or both ends of the coupling nut 10. This provides an opening 23 which is wider than the diameter of the all thread 22 which allows for imperfections at the end of the all thread 22 to be forced inward as the coupling nut 10 is mated with the all thread 22.

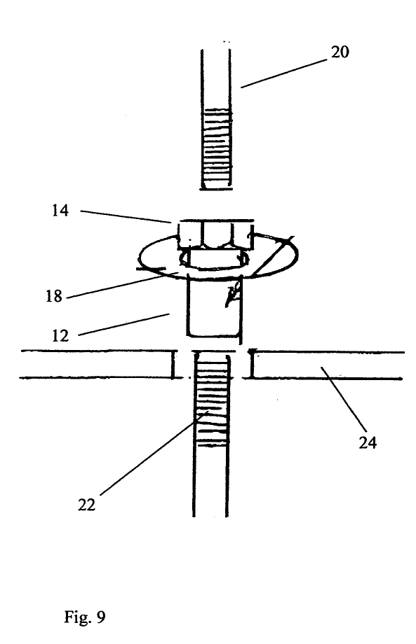

While the coupling nut 10 is preferably used with a separate washer 18 (see FIG. 9), the washer 18 could be included as an integral piece during the manufacture of the coupling nut 10 as shown in FIG. 8. A square washer 18 is preferred although other shapes are also acceptable.

Use of the invention is shown in FIG. 9. An all thread 22, which is firmly seated in the ground below the construction, extends substantially upward from the ground and through construction material 24 such as lumber, normally 2×4s. A hole is drilled through the lumber 24 to allow the all thread 22 to pass therethrough. The hole is large enough to allow both the all thread 22 and the coupling nut 10 to pass through. The all thread 22 is cut such that it does not extend above the lumber 24 through which it passes and such that the end of the all thread 22 is substantially even with the top surface of the lumber 24. A washer 18, which is larger than the hole in the lumber 24, is placed over the end of the coupling nut 10 and the coupling nut 10 is threaded onto the all thread 22 such that the washer 18 remains above the lumber 24. The coupling nut 10 is then tightened. The coupling nut 10 provides a sturdy connection to the all thread 22 such that the construction is anchored firmly to the ground. If desired and if the coupling nut 10 has a hollow head 14, a threaded rod 20 can be mated to the head 14 of the coupling nut 10.

While the description above refers to particular embodiments of the present invention, it will be understood that many modifications may be made without departing from the spirit thereof. The accompanying claims are intended to cover such modifications as would fall within the true scope and spirit of the present invention.

1. An apparatus for anchoring a building to the ground by means of a threaded rod, comprising:
a coupling nut having a head portion and a body portion wherein the outer diameter of the head portion is larger than the outer diameter of the body portion, the body portion is hollow and the inner surface of the body portion is threaded such that the coupling nut may be mated to the threaded rod to provide an anchor point between the building and the ground.

2. The apparatus of claim 1 wherein the head portion of the coupling nut is hollow and the inner surface of the head portion is threaded.

3. The apparatus of claim 1 wherein the coupling nut is made from a material selected from the group consisting of cold steel, galvanized steel, zinc plate coated steel and a composite material.

4. The apparatus of claim 1 wherein the coupling nut is formed through a molding process.

5. The apparatus of claim 1 wherein the coupling nut is formed through a welding process.

6. The apparatus of claim 1 wherein the head portion of the coupling nut is hexagonal in cross section.

7. The apparatus of claim 1 wherein the body portion of the coupling nut is circular in cross section.

8. The apparatus of claim 1 wherein the coupling nut further comprises an integral washer element.

9. The apparatus of claim 1 wherein the inner surface of the body portion of the coupling nut is tapered such that the diameter of an opening defined by the inner surface increases at the end of the body portion most distant from the head portion.

10. The apparatus of claim 2 wherein the inner surface of the head portion of the coupling nut is tapered such that the diameter of an opening defined by the inner surface of the head portion increases at the end of the head portion most distant from the body portion.
